(19) United States
(12) Patent Application Publication
(10) Pub. No.: US 2006/0093945 A1
(43) Pub. Date: May 4, 2006

(54) Dry toners comprising amphipathic copolymeric binder and volatile plasticizer

(76) Inventors: Eric Dalzell, North St. Paul, MN (US); Timothy Roberts, Chisago City, MN (US); Susan E. Hill, Woodbury, MN (US); Charles W. Simpson, Lakeland, MN (US); James A. Baker, Hudson, WI (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/978,911

(22) Filed: Oct. 31, 2004

(51) Int. Cl. G03G 9/087

(52) U.S. Cl. 430/109.1; 430/111.4; 430/137.1

(57) ABSTRACT

A low temperature fusing dry electrographic toner composition has a plurality of dry toner particles, wherein the toner particles comprise polymeric binder comprising at least one amphipathic copolymer comprising one or more S material portions and one or more D material portions. The dry electrographic toner composition comprises a volatile plasticizer in an amount effective to reduce the First Heat Exposure T_{g} by at least about 10° C. as compared to a like electrographic toner composition that does not comprise volatile plasticizer. The plasticizer is sufficiently volatile that the Second Heat Exposure T_{g} will increase by at least about 5° C. above the First Heat Exposure T_{g}. Methods of making and of using these compositions are also provided.

### FIELD OF THE INVENTION

The present invention relates to dry toner compositions having utility in electrography. More particularly, the invention relates to dry toner compositions comprising an amphipathic copolymer binder, and additionally comprising a volatile plasticizer.

### BACKGROUND OF THE INVENTION

In electrophotographic and electrostatic printing processes (collectively electrographic processes), an electrostatic image is formed on the surface of a photoreceptive element or dielectric element, respectively. The photoreceptive element or dielectric element can be an intermediate transfer drum or belt or the substrate for the final toned image itself, as described by Schmidt, S. P. and Larson, J. R. in Handbook of Imaging Materials Diamond, A. S., Ed: Marcel Dekker: New York; Chapter 6, pp 227-252, and U.S. Pat. Nos. 4,728,983, 4,321,404, and 4,268,598.

Electrophotography forms the technical basis for various well-known imaging processes, including photocopying and some forms of laser printing. Other imaging processes use electrostatic or ionographic printing. Electrostatic printing is printing where a dielectric receptor or substrate is “written” upon imagewise by a charged stylus, leaving a latent electrostatic image on the surface of the dielectric receptor. This dielectric receptor is not photosensitive and is generally not re-useable. Once the image pattern has been “written” onto the dielectric receptor in the form of an electrostatic charge pattern of positive or negative polarity, oppositely charged toner particles are applied to the dielectric receptor in order to develop the latent image. An exemplary electrostatic imaging process is described in U.S. Pat. No. 5,176,974. In contrast, electrophotographic imaging processes typically involve the use of a reusable, light sensitive, temporary image receptor, known as a photoreceptor, in the process of producing an electrophotographic image on a final, permanent image receptor. A representative electrophotographic process involves a series of steps to produce an image on a receptor, including charging, exposure, development, transfer, fusing, cleaning, and erasure.

In the charging step, a photoreceptor is covered with charge of a desired polarity, either negative or positive, typically with a corona or charging roller. In the exposure step, an optical system, typically a laser scanner or diode array, forms a latent image by selectively exposing the photoreceptor to electromagnetic radiation, thereby discharging the charged surface of the photoreceptor in an imagewise manner corresponding to the desired image to be formed on the final image receptor. The electromagnetic radiation, which can also be referred to as “light,” can include infrared radiation, visible light, and ultraviolet radiation, for example.

In the development step, toner particles of the appropriate polarity are generally brought into contact with the latent image on the photoreceptor, typically using a developer electrically-biased to a potential having the same polarity as the toner polarity. The toner particles migrate to the photoreceptor and selectively adhere to the latent image via electrostatic forces, forming a toned image on the photoreceptor.

In the transfer step, the toned image is transferred from the photoreceptor to the desired final image receptor; an intermediate transfer element is sometimes used to effect transfer of the toned image from the photoreceptor with subsequent transfer of the toned image to a final image receptor.

In the fusing step, the toned image on the final image receptor is heated to soften or melt the toner particles, thereby fusing the toned image to the final receptor. An alternative fusing method involves fixing the toner to the final receptor under high pressure with or without heat. In the cleaning step, residual toner remaining on the photoreceptor is removed. Finally, in the erasing step, the photoreceptor charge is reduced to a substantially uniformly low value by exposure to light of a particular wavelength band, thereby removing remnants of the original latent image and preparing the photoreceptor for the next imaging cycle.

Electrophotographic imaging processes can also be distinguished as being either multi-color or monochrome printing processes. Multi-color printing processes are commonly used for printing graphic art or photographic images, while monochrome printing is used primarily for printing text. Some multi-color electrophotographic printing processes use a multi-pass process to apply multiple colors as needed on the photoreceptor to create the composite image that will be transferred to the final image receptor, either by via an intermediate transfer member or directly. One example of such a process is described in U.S. Pat. No. 5,432,591.

A single-pass electrophotographic process for developing multiple color images is also known and can be referred to as a tandem process. A tandem color imaging process is discussed, for example in U.S. Pat. No. 5,916,718 and U.S. Pat. No. 5,420,676. In a tandem process, the photoreceptor accepts color from developer stations that are spaced from each other in such a way that only a single pass of the photoreceptor results in application of all of the desired colors thereon.

Alternatively, electrophotographic imaging processes can be purely monochromatic. In these systems, there is typically only one pass per page because there is no need to overlay colors on the photoreceptor. Monochromatic processes may, however, include multiple passes where necessary to achieve higher image density or a drier image on the final image receptor, for example.

Two types of toner are in widespread, commercial use: liquid toner and dry toner. The term “dry” does not mean that the dry toner is totally free of any liquid constituents, but connotes that the toner particles do not contain any significant amount of solvent, e.g., typically less than 10 weight percent solvent (generally, dry toner is as dry as is reasonably practical in terms of solvent content), and are capable of carrying a triboelectric charge. This distinguishes dry toner particles from liquid toner particles.

In electrographic printing with dry toners the durability (e.g. erasure and blocking resistance) and archivability of the toned image on a final image receptor such as paper is often of critical importance to the end user. The nature of the final image receptor (e.g. composition, thickness, porosity, surface energy and surface roughness), the nature of the fusing process (e.g. non-contact fusing involving a heat source or contact fusing involving pressure, often in combination with a heat source), and the nature of the toner particles (e.g. developed mass per unit area, particle size and shape, composition and glass transition temperature (T_{g}) of the toner particles and molecular weight and melt rheology of the polymeric binders used to make the toner particles), may all affect the durability of the final toned image as well as the energy required to heat the fuser assembly to the proper fusing temperature. The proper fusing temperature is operationally defined as the minimum temperature range above the T_{g} at which the fused toned image develops sufficient adhesion to the final image receptor to resist removal by abrasion or cracking (see, e.g., L. DeMejo, et al., SPIE Hard Copy and Printing Materials, Media, and Process, 1253, 85 (1990); and T. Satoh, et al., Journal of Imaging Science, 35 (6), 373 (1991).). Minimizing the proper fusing temperature is desirable because the time required to heat the fuser assembly to the proper temperature will be reduced, the power consumed to maintain the fuser assembly at the proper temperature will be reduced, and the thermal demands on the fuser roll materials will be reduced if the minimum fusing temperature can be reduced. The art continually searches for improved dry toner compositions that produce high quality, durable images at low fusion temperatures on a final image receptor.

### SUMMARY OF THE INVENTION

The present invention relates to low temperature fusing dry electrographic toner compositions comprising toner particles. The toner particles comprise polymeric binder comprising at least one amphipathic copolymer comprising one or more S material portions and one or more D material portions. The dry electrographic toner composition comprises a volatile plasticizer in an amount effective to reduce a First Heat Exposure T_{g}, by at least about 10° C. as compared to a like electrographic toner composition that does not comprise volatile plasticizer, wherein the plasticizer is sufficiently volatile that a Second Heat Exposure T_{g}, will increase by at least about 5° C. above the First Heat Exposure T_{g}. For purposes of the present invention, the First Heat Exposure T_{g}, is the measurable T_{g}, of the polymeric binder on first exposure to elevated heat after formation of the dry toner composition. Likewise, the Second Heat Exposure T_{g}, is the measurable T_{g}, of the polymeric binder (i.e. higher than the minimum effective fusing temperature) when measured after the dry toner composition has been exposed once to a temperature higher than the T_{g} of the polymeric binder as measured in a First Heat Exposure T_{g}, measurement.

Surprisingly, the formulations of amphipathic copolymer as described herein provide dry toners that can exhibit excellent final image durability characteristics, and can also provide a toner composition that provides excellent images at low fusion temperatures on a final image receptor. The images that are formed from toner compositions of the present invention can exhibit excellent durability and erasure resistance properties. While not being bound by theory, it is believed that the volatile plasticizer plasticizes the binder of the toner particle during the imaging process, and particularly in the fusing step of the imaging process, thereby lowering the effective glass transition temperature of the toner particle and providing a toner having an initial low fusing temperature. Due to the volatility of this plasticizer, a significant portion of the plasticizer is removed from the toner during the heating/fusing process. Once the image is fused on the substrate, the measured T_{g} of the binder substantially increases sufficient to impart good durability and archivability to the fused toned image, though not necessarily to the same high T_{g} as a like electrographic toner composition that does not comprise volatile plasticizer.

The use of volatile plasticizer in electrographic toner compositions beneficially allows formulation of toner particles using materials that otherwise would not be suitable for use in these compositions, because the fusing temperature would otherwise be unacceptably high.

### BRIEF DESCRIPTION OF THE DRAWING

FIG. 1 shows a Differential Scanning Calorimetry plot of an exemplary volatile plasticizer.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention.

The toner particles of the dry toner composition comprise a polymeric binder that comprises an amphipathic copolymer. The term “amphipathic” refers to a copolymer having a combination of portions having distinct solubility and dispersibility characteristics in a desired liquid carrier that is used to make the organosol and/or used in the course of preparing the dry toner particles. Preferably, the liquid carrier is selected such that at least one portion (also referred to herein as S material or portion(s)) of the copolymer is more solvated by the carrier while at least one other portion (also referred to herein as D material or portion(s)) of the copolymer constitutes more of a dispersed phase in the carrier.

Preferably, the nonaqueous liquid carrier of the organosol is selected such that at least one portion (also referred to herein as the S material or portion) of the amphipathic copolymer is more solvated by the carrier while at least one other portion (also referred to herein as the D material or portion) of the copolymer constitutes more of a dispersed phase in the carrier. In other words, preferred copolymers of the present invention comprise S and D material having respective solubilities in the desired liquid carrier that are sufficiently different from each other such that the S blocks tend to be more solvated by the carrier while the D blocks tend to be more dispersed in the carrier. More preferably, the S blocks are soluble in the liquid carrier while the D blocks are insoluble. In particularly preferred embodiments, the D material phase separates from the liquid carrier, forming dispersed particles.

From one perspective, the polymer particles when dispersed in the liquid carrier can be viewed as having a core/shell structure in which the D material tends to be in the core, while the S material tends to be in the shell. The S material thus functions as a dispersing aid, steric stabilizer or graft copolymer stabilizer, to help stabilize dispersions of the copolymer particles in the liquid carrier. Consequently, the S material can also be referred to herein as a “graft stabilizer.” The core/shell structure of the binder particles tends to be retained when the particles are dried when incorporated into dry toner particles.

Plasticizer to be incorporated in the toner composition is provided in an amount effective to reduce the First Heat Exposure T_{g} by at least about 10° C. as compared to a like electrographic toner composition that does not comprise volatile plasticizer. This First Heat Exposure T_{g} (and subsequent measurements) is measured using a Differential Scanning Calorimeter, as discussed in more detail below. The heating and cooling rates of this measurement are as set forth below, and are in a similar rate as in imaging conditions to provide a useful model of toner particle (and plasticizer) behavior under conditions of use. Preferably, the plasticizer is present in an amount of from about 0.01 to about 6% (w/w), more preferably from about 0.02 to about 2% (w/w) and most preferably from about 0.04 to about 1.2% (w/w), of the dry electrographic toner composition. This would correspond to an amount in the precursor liquid toner of about between 0.2 to about 5.0% (w/w) based on carrier liquid. It is surprising that this small amount of plasticizer has a significant impact on the T_{g} of the toner particle composition.

Additionally, the plasticizer is sufficiently volatile that the Second Heat Exposure T_{g} will increase by at least about 5° C. above the First Heat Exposure T_{g}. The volatility of a plasticizer is in part determined by its boiling point, but also significantly is affected by its affinity to the toner particle itself as well. Thus, one must evaluate the entire system to determine whether a plasticizer will be volatile from a specific toner particle chemistry. This evaluation can be carried out by consideration of solvency principles, or by routine experimentation with the teachings as provided herein. It has surprisingly been found that certain plasticizers will behave as volatile plasticizers at low concentrations, but will act as non-volatile plasticizers at higher concentrations. While not being bound by theory, it is believed that when a larger amount of the plasticizer is initially provided in the toner particle, a significant portion thereof remains at or in the particle after the fusion step (modeled by the First Heat Exposure T_{g}), and T_{g} suppression continues in the manner of a non-volatile plasticizer. Routine evaluation thus is desirable not only of the chemical composition of the plasticizer, but the concentration of the plasticizer to be used in a particular toner particle composition.

Preferred plasticizers include straight, branched or cyclo-lower alkyl compounds; straight, branched or cyclo-lower alkyl phthalate compounds; straight, branched or cyclo-lower alkyl esters; C₇-C₁₁ isoparaffinic solvents; and mixtures thereof. For purposes of the present invention, a lower alkyl group is a C₁-C₉ alkyl, and preferably is a C₁-C₆ alkyl group. Other preferred plasticizers include volatile machining oils. Particularly preferred plasticizers are methyl oleate, heptane, dibutyl phthalate, C₁₀-C₁₁ isoparaffins, and low boiling synthetic hydrocarbon blends.

The solubility of a material, or a portion of a material such as a copolymeric portion, can be qualitatively and quantitatively characterized in terms of its Hildebrand solubility parameter. The Hildebrand solubility parameter refers to a solubility parameter represented by the square root of the cohesive energy density of a material, having units of (pressure)^{1/2}, and being equal to (ΔH/RT)^{1/2}/V^{1/2}, where ΔH is the molar vaporization enthalpy of the material, R is the universal gas constant, T is the absolute temperature, and V is the molar volume of the solvent. Hildebrand solubility parameters are tabulated for solvents in Barton, A. F. M., Handbook of Solubility and Other Cohesion Parameters, 2d Ed. CRC Press, Boca Raton, Fla., (1991), for monomers and representative polymers in Polymer Handbook, 3rd Ed., J. Brandrup & E. H. Immergut, Eds. John Wiley, N.Y., pp 519-557 (1989), and for many commercially available polymers in Barton, A. F. M., Handbook of Polymer-Liquid Interaction Parameters and Solubility Parameters, CRC Press, Boca Raton, Fla., (1990).

The degree of solubility of a material, or portion thereof, in a liquid carrier can be predicted from the absolute difference in Hildebrand solubility parameters between the material, or portion thereof, and the liquid carrier. A material, or portion thereof, will be fully soluble or at least in a highly solvated state when the absolute difference in Hildebrand solubility parameter between the material, or portion thereof, and the liquid carrier is less than approximately 1.5 MPa^{1/2}. On the other hand, when the absolute difference between the Hildebrand solubility parameters exceeds approximately 3.0 MPa^{1/2}, the material, or portion thereof, will tend to phase separate from the liquid carrier, forming a dispersion. When the absolute difference in Hildebrand solubility parameters is between 1.5 MPa^{1/2} and 3.0 MPa^{1/2}, the material, or portion thereof, is considered to be weakly solvatable or marginally insoluble in the liquid carrier.

Consequently, in preferred embodiments, the absolute difference between the respective Hildebrand solubility parameters of the S material portion(s) of the copolymer and the liquid carrier is less than 3.0 MPa^{1/2}. In a preferred embodiment of the present invention, the absolute difference between the respective Hildebrand solubility parameters of the S material portion(s) of the copolymer and the liquid carrier is from about 2 to about 3.0 MPa^{1/2}. In a particularly preferred embodiment of the present invention, the absolute difference between the respective Hildebrand solubility parameters of the S material portion(s) of the copolymer and the liquid carrier is from about 2.5 to about 3.0 MPa^{1/2}. Additionally, it is also preferred that the absolute difference between the respective Hildebrand solubility parameters of the D material portion(s) of the copolymer and the liquid carrier is greater than 2.3 MPa^{1/2}, preferably greater than about 2.5 MPa^{1/2}, more preferably greater than about 3.0 MPa^{1/2}, with the proviso that the difference between the respective Hildebrand solubility parameters of the S and D material portion(s) is at least about 0.4 MPa^{1/2}, more preferably at least about 1.0 MPa^{1/2}. Because the Hildebrand solubility of a material can vary with changes in temperature, such solubility parameters are preferably determined at a desired reference temperature such as at 25° C.

Those skilled in the art understand that the Hildebrand solubility parameter for a copolymer, or portion thereof, can be calculated using a volume fraction weighting of the individual Hildebrand solubility parameters for each monomer comprising the copolymer, or portion thereof, as described for binary copolymers in Barton A. F. M., Handbook of Solubility Parameters and Other Cohesion Parameters, CRC Press, Boca Raton, p 12 (1990). The magnitude of the Hildebrand solubility parameter for polymeric materials is also known to be weakly dependent upon the weight average molecular weight of the polymer, as noted in Barton, pp 446-448. Thus, there will be a preferred molecular weight range for a given polymer or portion thereof in order to achieve desired solvating or dispersing characteristics. Similarly, the Hildebrand solubility parameter for a mixture can be calculated using a volume fraction weighting of the individual Hildebrand solubility parameters for each component of the mixture.

In addition, we have defined our invention in terms of the calculated solubility parameters of the monomers and solvents obtained using the group contribution method developed by Small, P. A., J. Appl. Chem., 3, 71 (1953) using Small's group contribution values listed in Table 2.2 on page VII/525 in the Polymer Handbook, 3rd Ed., J. Brandrup & E. H. Immergut, Eds. John Wiley, New York, (1989). We have chosen this method for defining our invention to avoid ambiguities which could result from using solubility parameter values obtained with different experimental methods. In addition, Small's group contribution values will generate solubility parameters that are consistent with data derived from measurements of the enthalpy of vaporization, and therefore are completely consistent with the defining expression for the Hildebrand solubility parameter. Since it is not practical to measure the heat of vaporization for polymers, monomers are a reasonable substitution.

For purposes of illustration, Table I lists Hildebrand solubility parameters for some common solvents used in an electrographic toner and the Hildebrand solubility parameters and glass transition temperatures (based on their high molecular weight homopolymers) for some common monomers used in synthesizing organosols.

TABLE I
Hildebrand Solubility Parameters Solvent Values at 25° C.

| | Kauri-Butanol | |
|---|---|---|
| | Number by ASTM | |
| | Method D1133- | Hildebrand Solubility |
| Solvent Name | 54T (ml) | Parameter (Mpa^{1/2}) |
| Norpar ™ 15 | 18 | 13.99 |
| Norpar ™ 13 | 22 | 14.24 |
| Norpar ™ 12 | 23 | 14.30 |
| Isopar ™ V | 25 | 14.42 |
| Isopar ™ G | 28 | 14.60 |
| Exxsol ™ D80 | 28 | 14.60 |

Source: Calculated from equation #31 of Polymer Handbook, 3^{rd} Ed., J.
Brandrup E. H. Immergut, Eds. John Wiley, NY, p. VII/522 (1989).

Monomer Values at 25° C.

| | Hildebrand | |
|---|---|---|
| | Solubility | Glass Transition |
| Monomer Name | Parameter (MPa^{1/2}) | Temperature (° C.)* |
| 3,3,5-Trimethyl | 16.73 | 125 |
| Cyclohexyl Methacrylate | | |
| Isobornyl Methacrylate | 16.90 | 110 |
| Isobornyl Acrylate | 16.01 | 94 |
| n-Behenyl acrylate | 16.74 | <−55 (58 m.p.)** |
| n-Octadecyl Methacrylate | 16.77 | −100 (28 m.p.)** |
| n-Octadecyl Acrylate | 16.82 | −55 (42 m.p.)** |
| Lauryl Methacrylate | 16.84 | −65 |
| Lauryl Acrylate | 16.95 | −30 |
| 2-Ethylhexyl Methacrylate | 16.97 | −10 |
| 2-Ethylhexyl Acrylate | 17.03 | −55 |
| n-Hexyl Methacrylate | 17.13 | −5 |
| t-Butyl Methacrylate | 17.16 | 107 |
| n-Butyl Methacrylate | 17.22 | 20 |
| n-Hexyl Acrylate | 17.30 | −60 |
| n-Butyl Acrylate | 17.45 | −55 |
| Ethyl Methacrylate | 17.62 | 65 |
| Ethyl Acrylate | 18.04 | −24 |
| Methyl Methacrylate | 18.17 | 105 |
| Styrene | 18.05 | 100 |

Calculated using Small's Group Contribution Method, Small, P.A. Journal of Applied Chemistry 3 p. 71 (1953). Using Group Contributions from Polymer Handbook, 3^{rd} Ed., J. Brandrup E. H. Immergut, Eds., John Wiley, NY, p. VII/525 (1989).
*Polymer Handbook, 3^{rd} Ed., J. Brandrup E. H. Immergut, Eds., John Wiley, NY, pp. VII/209-277 (1989). The T_{g} listed is for the homopolymer of the respective monomer.
**m.p. refers to melting point for selected Polymerizable Crystallizable Compounds.

The liquid carrier is a substantially nonaqueous solvent or solvent blend. In other words, only a minor component (generally less than 25 weight percent) of the liquid carrier comprises water. Preferably, the substantially nonaqueous liquid carrier comprises less than 20 weight percent water, more preferably less than 10 weight percent water, even more preferably less than 3 weight percent water, most preferably less than one weight percent water.

The substantially nonaqueous liquid carrier can be selected from a wide variety of materials, or combination of materials, which are known in the art, but preferably has a Kauri-butanol number less than 30 ml. The liquid is preferably oleophilic, chemically stable under a variety of conditions, and electrically insulating. Electrically insulating refers to a dispersant liquid having a low dielectric constant and a high electrical resistivity. Preferably, the liquid dispersant has a dielectric constant of less than 5; more preferably less than 3. Electrical resistivities of carrier liquids are typically greater than 10⁹ Ohm-cm; more preferably greater than 10¹⁰ Ohm-cm. In addition, the liquid carrier desirably is chemically inert in most embodiments with respect to the ingredients used to formulate the toner particles.

Examples of suitable liquid carriers include aliphatic hydrocarbons (n-pentane, hexane, heptane and the like), cycloaliphatic hydrocarbons (cyclopentane, cyclohexane and the like), aromatic hydrocarbons (benzene, toluene, xylene and the like), halogenated hydrocarbon solvents (chlorinated alkanes, fluorinated alkanes, chlorofluorocarbons and the like) silicone oils and blends of these solvents. Preferred liquid carriers include branched paraffinic solvent blends such as Isopar™ G, Isopar™ H, Isopar™ K, Isopar™ L, Isopar™ M and Isopar™ V (available from Exxon Corporation, N.J.), and most preferred carriers are the aliphatic hydrocarbon solvent blends such as Norpar™ 12, Norpar™ 13 and Norpar™ 15 (available from Exxon Corporation, N.J.). Particularly preferred liquid carriers have a Hildebrand solubility parameter of from about 13 to about 15 MPa^{1/2}.

As used herein, the term “copolymer” encompasses both oligomeric and polymeric materials, and encompasses polymers incorporating two or more monomers. As used herein, the term “monomer” means a relatively low molecular weight material (i.e., generally having a molecular weight less than about 500 Daltons) having one or more polymerizable groups. “Oligomer” means a relatively intermediate sized molecule incorporating two or more monomers and generally having a molecular weight of from about 500 up to about 10,000 Daltons. “Polymer” means a relatively large material comprising a substructure formed two or more monomeric, oligomeric, and/or polymeric constituents and generally having a molecular weight greater than about 10,000 Daltons.

The weight average molecular weight of the amphipathic copolymer of the present invention can vary over a wide range, and can impact imaging performance. The polydispersity of the copolymer also can impact imaging and transfer performance of the resultant dry toner material. Because of the difficulty of measuring molecular weight for an amphipathic copolymer, the particle size of the dispersed copolymer (organosol) can instead be correlated to imaging and transfer performance of the resultant dry toner material. Generally, the volume mean particle diameter (Dᵥ) of the toner particles, determined by laser diffraction particle size measurement, preferably should be in the range of about 0.1 to about 100.0 microns, more preferably in the range of about 1 to about 20 microns, most preferably in the range of about 5 to about 10 microns.

In addition, a correlation exists between the molecular weight of the solvatable or soluble S material portion of the graft copolymer, and the imaging and transfer performance of the resultant toner. Generally, the S material portion of the copolymer has a weight average molecular weight in the range of 1000 to about 1,000,000 Daltons, preferably 5000 to 400,000 Daltons, more preferably 50,000 to 300,000 Daltons. It is also generally desirable to maintain the polydispersity (the ratio of the weight-average molecular weight to the number average molecular weight) of the S material portion of the copolymer below 15, more preferably below 5, most preferably below 2.5. It is a distinct advantage of the present invention that copolymer particles with such lower polydispersity characteristics for the S material portion are easily made in accordance with the practices described herein, particularly those embodiments in which the copolymer is formed in the liquid carrier in situ.

The relative amounts of S and D material portions in a copolymer can impact the solvating and dispersability characteristics of these portions. For instance, if too little of the S material portion(s) are present, the copolymer can have too little stabilizing effect to sterically-stabilize the organosol with respect to aggregation as might be desired. If too little of the D material portion(s) are present, the small amount of D material can be too soluble in the liquid carrier such that there can be insufficient driving force to form a distinct particulate, dispersed phase in the liquid carrier. The presence of both a solvated and dispersed phase helps the ingredients of particles self assemble in situ with exceptional uniformity among separate particles. Balancing these concerns, the preferred weight ratio of D material to S material is in the range of 1/20 to 20/1, preferably 1/1 to 15/1, more preferably 2/1 to 10/1, and most preferably 4/1 to 8/1.

Glass transition temperature, T_{g}, refers to the temperature at which a (co)polymer, or portion thereof, changes from a hard, glassy material to a rubbery, or viscous, material, corresponding to a dramatic increase in free volume as the (co)polymer is heated. The T_{g} can be calculated for a (co)polymer, or portion thereof, using known T_{g} values for the high molecular weight homopolymers (see, e.g., Table I herein) and the Fox equation expressed below:
1/T_{g}=w₁/T_{g1}+w₂/T_{g2}+ . . . wᵢ/T_{gi}
wherein each wₙ is the weight fraction of monomer “n” and each T_{gn} is the absolute glass transition temperature (in degrees Kelvin) of the high molecular weight homopolymer of monomer “n” as described in Wicks, A. W., F. N. Jones & S. P. Pappas, Organic Coatings 1, John Wiley, NY, pp 54-55 (1992).

In the practice of the present invention, values of T_{g} for the D or S material portion of the copolymer or of the soluble polymer were determined either using the Fox equation above or experimentally, using e.g., differential scanning calorimetry. The glass transition temperatures (T_{g}'s) of the S and D material portions can vary over a wide range and can be independently selected to enhance manufacturability and/or performance of the resulting dry toner particles. The T_{g}'s of the S and D material portions will depend to a large degree upon the type of monomers constituting such portions. Consequently, to provide a copolymer material with higher T_{g}, one can select one or more higher T_{g} monomers with the appropriate solubility characteristics for the type of copolymer portion (D or S) in which the monomer(s) will be used. Conversely, to provide a copolymer material with lower T_{g}, one can select one or more lower T_{g} monomers with the appropriate solubility characteristics for the type of portion in which the monomer(s) will be used.

Polymeric binder materials suitable for use in dry toner particles typically have a high glass transition temperature (T_{g}) of at least about 50-65° C. in order to obtain good blocking resistance after fusing, yet typically require high fusing temperatures of about 200-250° C. in order to soften or melt the toner particles and thereby adequately fuse the toner to the final image receptor. High fusing temperatures are a disadvantage for dry toner because of the long warm-up time and higher energy consumption associated with high temperature fusing and because of the risk of fire associated with fusing toner to paper at temperatures approaching the autoignition temperature of paper (233° C.).

In addition, some dry toners using high T_{g} polymeric binders are known to exhibit undesirable partial transfer (offset) of the toned image from the final image receptor to the fuser surface at temperatures above or below the optimal fusing temperature, requiring the use of low surface energy materials in the fuser surface or the application of fuser oils to prevent offset. Alternatively, various lubricants or waxes have been physically blended into the dry toner particles during fabrication to act as release or slip agents; however, because these waxes are not chemically bonded to the polymeric binder, they may adversely affect triboelectric charging of the toner particle or may migrate from the toner particle and contaminate the photoreceptor, an intermediate transfer element, the fuser element, or other surfaces critical to the electrophotographic process.

A wide variety of one or more different monomeric, oligomeric and/or polymeric materials can be independently incorporated into the S and D material portions, as desired. Representative examples of suitable materials include free radically polymerized material (also referred to as vinyl copolymers or (meth) acrylic copolymers in some embodiments), polyurethanes, polyester, epoxy, polyamide, polyimide, polysiloxane, fluoropolymer, polysulfone, combinations of these, and the like. Preferred S and D material portions are derived from free radically polymerizable material. In the practice of the present invention, “free radically polymerizable” refers to monomers, oligomers, and/or polymers having functionality directly or indirectly pendant from a monomer, oligomer, or polymer backbone (as the case can be) that participate in polymerization reactions via a free radical mechanism. Representative examples of such functionality includes (meth)acrylate groups, olefinic carbon-carbon double bonds, allyloxy groups, alpha-methyl styrene groups, (meth)acrylamide groups, cyanate ester groups, vinyl ether groups, combinations of these, and the like. The term “(meth)acryl”, as used herein, encompasses acryl and/or methacryl.

Free radically polymerizable monomers, oligomers, and/or polymers are advantageously used to form the copolymer in that so many different types are commercially available and can be selected with a wide variety of desired characteristics that help provide one or more desired performance characteristics. Free radically polymerizable monomers, oligomers, and/or monomers suitable in the practice of the present invention can include one or more free radically polymerizable moieties.

Representative examples of monofunctional, free radically polymerizable monomers include styrene, alpha-methylstyrene, substituted styrene, vinyl esters, vinyl ethers, N-vinyl-2-pyrrolidone, (meth)acrylamide, vinyl naphthalene, alkylated vinyl naphthalenes, alkoxy vinyl naphthalenes, N-substituted (meth)acrylamide, octyl (meth)acrylate, nonylphenol ethoxylate (meth)acrylate, N-vinyl pyrrolidone, isononyl (meth)acrylate, isobornyl (meth)acrylate, 2-(2-ethoxyethoxy)ethyl (meth)acrylate, 2-ethylhexyl (meth)acrylate, beta-carboxyethyl (meth)acrylate, isobutyl (meth)acrylate, cycloaliphatic epoxide, alpha-epoxide, 2-hydroxyethyl (meth)acrylate, (meth)acrylonitrile, maleic anhydride, itaconic acid, isodecyl (meth)acrylate, lauryl (dodecyl) (meth)acrylate, stearyl (octadecyl) (meth)acrylate, behenyl (meth)acrylate, n-butyl (meth)acrylate, methyl (meth)acrylate, ethyl (meth)acrylate, hexyl (meth)acrylate, (meth)acrylic acid, N-vinylcaprolactam, stearyl (meth)acrylate, hydroxy functional caprolactone ester (meth)acrylate, isooctyl (meth)acrylate, hydroxyethyl (meth)acrylate, hydroxymethyl (meth)acrylate, hydroxypropyl (meth)acrylate, hydroxyisopropyl (meth)acrylate, hydroxybutyl (meth)acrylate, hydroxyisobutyl (meth)acrylate, tetrahydrofurfuryl (meth)acrylate, isobornyl (meth)acrylate, glycidyl (meth)acrylate vinyl acetate, combinations of these, and the like.

The monomeric components that are reacted to form the S material portions are, in one embodiment of the present invention, selected to provide the desired T_{g} of the S material portion by selection of monomers having T_{g} s within a given range, matched with solubility parameter characteristics. Advantageously, the fusion characteristics and durability property characteristics of the toner and the resulting image formed therefrom can be manipulated by selection of relative T_{g} s of components of S material portions of the amphipathic copolymer. In this manner, performance characteristics of toner compositions can be readily tailored and/or optimized for use in desired imaging systems.

The S material portion is preferably made from (meth)acrylate based monomers and comprises the reaction products of soluble monomers selected from the group consisting of trimethyl cyclohexyl methacrylate; t-butyl methacrylate; n-butyl methacrylate; isobornyl (meth)acrylate; 1,6-Hexanediol di(meth)acrylate; 2-hydroxyethyl methacrylate; lauryl methacrylate; and combinations thereof.

Preferred copolymers of the present invention can be formulated with one or more radiation curable monomers or combinations thereof that help the free radically polymerizable compositions and/or resultant cured compositions to satisfy one or more desirable performance criteria.

An exemplary class of radiation curable monomers that tend to have relatively high T_{g} characteristics suitable for incorporation into the high T_{g} component generally comprise at least one radiation curable (meth)acrylate monomer and at least one nonaromatic, alicyclic and/or nonaromatic heterocyclic monomer. Isobornyl(meth)acrylate is a specific example of one such monomer. A cured, homopolymer film formed from isobornyl acrylate, for instance, has a T_{g} of 110° C. The monomer itself has a molecular weight of 222 g/mole, exists as a clear liquid at room temperature, has a viscosity of 9 centipoise at 25° C., and has a surface tension of 31.7 dynes/cm at 25° C. Additionally, 1,6-Hexanediol di(meth)acrylate is another example of a monomer with high T_{g} characteristics. Other examples of preferred high T_{g} components include trimethyl cyclohexyl methacrylate; t-butyl methacrylate; n-butyl methacrylate. Combinations of high T_{g} components for use in both the S material portion and the soluble polymer are specifically contemplated, together with anchor grafting groups such as provided by use of HEMA subsequently reacted with TMI.

Examples of graft amphipathic copolymers that may be used in the present binder particles are described in Qian et al, U.S. Ser. No. 10/612,243, filed on Jun. 30, 2003, entitled ORGANOSOL INCLUDING AMPHIPATHIC COPOLYMERIC BINDER AND USE OF THE ORGANOSOL TO MAKE DRY TONERS FOR ELECTROGRAPHIC APPLICATIONS and Qian et al., U.S. Ser. No. 10/612,535, filed on Jun. 30, 2003, entitled ORGANOSOL INCLUDING AMPHIPATHIC COPOLYMERIC BINDER HAVING CRYSTALLINE MATERIAL, AND USE OF THE ORGANOSOL TO MAKE DRY TONER FOR ELECTROGRAPHIC APPLICATIONS for dry toner compositions.

Copolymers of the present invention can be prepared by free-radical polymerization methods known in the art, including but not limited to bulk, solution, and dispersion polymerization methods. The resultant copolymers can have a variety of structures including linear, branched, three dimensionally networked, graft-structured, combinations thereof, and the like. A preferred embodiment is a graft copolymer comprising one or more oligomeric and/or polymeric arms attached to an oligomeric or polymeric backbone. In graft copolymer embodiments, the S material portion or D material portion materials, as the case can be, can be incorporated into the arms and/or the backbone.

Any number of reactions known to those skilled in the art can be used to prepare a free radically polymerized copolymer having a graft structure. Common grafting methods include random grafting of polyfunctional free radicals; copolymerization of monomers with macromonomers; ring-opening polymerizations of cyclic ethers, esters, amides or acetals; epoxidations; reactions of hydroxyl or amino chain transfer agents with terminally-unsaturated end groups; esterification reactions (i.e., glycidyl methacrylate undergoes tertiary-amine catalyzed esterification with methacrylic acid); and condensation polymerization.

Representative methods of forming graft copolymers are described in U.S. Pat. Nos. 6,255,363; 6,136,490; and 5,384,226; and Japanese Published Patent Document No. 05-119529, incorporated herein by reference. Representative examples of grafting methods are also described in sections 3.7 and 3.8 of Dispersion Polymerization in Organic Media, K. E. J. Barrett, ed., (John Wiley; New York, 1975) pp. 79-106, also incorporated herein by reference.

In preferred embodiments, the copolymer is polymerized in situ in the desired liquid carrier, as this yields substantially monodisperse copolymeric particles suitable for use in toner compositions. The resulting organosol is then preferably mixed with at least one visual enhancement additive and optionally one or more other desired ingredients to form a desired toner particle. During such combination, ingredients comprising the visual enhancement particles and the copolymer will tend to self-assemble into composite particles having solvated (S) portions and dispersed (D) portions. Specifically, it is believed that the D material of the copolymer will tend to physically and/or chemically interact with the surface of the visual enhancement additive, while the S material helps promote dispersion in the carrier.

Representative examples of grafting methods also can use an anchoring group. The function of the anchoring group is to provide a covalently bonded link between the core part of the copolymer (the D material) and the soluble shell component (the S material). Preferred amphipathic copolymers are prepared by first preparing an intermediate S material portion comprising reactive functionality by a polymerization process, and subsequently reacting the available reactive functionalities with a graft anchoring compound. The graft anchoring compound comprises a first functionality that can be reacted with the reactive functionality on the intermediate S material portion, and a second functionality that is a polymerizably reactive functionality that can take part in a polymerization reaction. After reaction of the intermediate S material portion with the graft anchoring compound, a polymerization reaction with selected monomers can be carried out in the presence of the S material portion to form a D material portion having one or more S material portions grafted thereto.

Suitable monomers containing anchoring groups include: adducts of alkenylazlactone comonomers with an unsaturated nucleophile containing hydroxy, amino, or mercaptan groups, such as 2-hydroxyethylmethacrylate, 3-hydroxypropylmethacrylate, 2-hydroxyethylacrylate, pentaerythritol triacrylate, 4-hydroxybutylvinylether, 9-octadecen-1-ol, cinnamyl alcohol, allyl mercaptan, methallylamine; and azlactones, such as 2-alkenyl-4,4-dialkylazlactone.

The preferred methodology described above accomplishes grafting via attaching an ethylenically-unsaturated isocyanate (e.g., dimethyl-m-isopropenyl benzylisocyanate, TMI, available from CYTEC Industries, West Paterson, N.J.; or isocyanatoethyl methacrylate, IEM) to hydroxyl groups in order to provide free radically reactive anchoring groups.

A preferred method of forming a graft copolymer of the present invention involves three reaction steps that are carried out in a suitable substantially nonaqueous liquid carrier in which resultant S material is soluble while D material is dispersed or insoluble.

In a first preferred step, a hydroxyl functional, free radically polymerized oligomer or polymer is formed from one or more monomers, wherein at least one of the monomers has pendant hydroxyl functionality. Preferably, the hydroxyl functional monomer constitutes about 1 to about 30, preferably about 2 to about 10 percent, most preferably 3 to about 5 percent by weight of the monomers used to form the oligomer or polymer of this first step. This first step is preferably carried out via solution polymerization in a substantially nonaqueous solvent in which the monomers and the resultant polymer are soluble. For instance, using the Hildebrand solubility data in Table 1, monomers such as octadecyl methacrylate, octadecyl acrylate, lauryl acrylate, and lauryl methacrylate are suitable for this first reaction step when using an oleophilic solvent such as heptane or the like.

In a second reaction step, all or a portion of the hydroxyl groups of the soluble polymer are catalytically reacted with an ethylenically unsaturated aliphatic isocyanate (e.g. meta-isopropenyldimethylbenzyl isocyanate commonly known as TMI or isocyanatoethyl methacrylate, commonly known as IEM) to form pendant free radically polymerizable functionality which is attached to the oligomer or polymer via a polyurethane linkage. This reaction can be carried out in the same solvent, and hence the same reaction vessel, as the first step. The resultant double-bond functionalized polymer generally remains soluble in the reaction solvent and constitutes the S material portion material of the resultant copolymer, which ultimately will constitute at least a portion of the solvatable portion of the resultant triboelectrically charged particles.

The resultant free radically reactive functionality provides grafting sites for attaching D material and optionally additional S material to the polymer. In a third step, these grafting site(s) are used to covalently graft such material to the polymer via reaction with one or more free radically reactive monomers, oligomers, and or polymers that are initially soluble in the solvent, but then become insoluble as the molecular weight of the graft copolymer. For instance, using the Hildebrand solubility parameters in Table 1, monomers such as e.g. methyl (meth)acrylate, ethyl (meth)acrylate, t-butyl methacrylate and styrene are suitable for this third reaction step when using an oleophilic solvent such as heptane or the like.

The product of the third reaction step is generally an organosol comprising the resultant copolymer dispersed in the reaction solvent, which constitutes a substantially nonaqueous liquid carrier for the organosol. At this stage, it is believed that the copolymer tends to exist in the liquid carrier as discrete, monodisperse particles having dispersed (e.g., substantially insoluble, phase separated) portion(s) and solvated (e.g., substantially soluble) portion(s). As such, the solvated portion(s) help to sterically-stabilize the dispersion of the particles in the liquid carrier. It can be appreciated that the copolymer is thus advantageously formed in the liquid carrier in situ.

Before further processing, the copolymer particles can remain in the reaction solvent. Alternatively, the particles can be transferred in any suitable way into fresh solvent that is the same or different so long as the copolymer has solvated and dispersed phases in the fresh solvent. In either case, the resulting organosol is then converted into toner particles by mixing the organosol with at least one visual enhancement additive. Optionally, one or more other desired ingredients also can be mixed into the organosol before and/or after combination with the visual enhancement particles. During such combination, it is believed that ingredients comprising the visual enhancement additive and the copolymer will tend to self-assemble into composite particles having a structure wherein the dispersed phase portions generally tend to associate with the visual enhancement additive particles (for example, by physically and/or chemically interacting with the surface of the particles), while the solvated phase portions help promote dispersion in the carrier.

The visual enhancement additive(s) generally may include any one or more fluid and/or particulate materials that provide a desired visual effect when toner particles incorporating such materials are printed onto a receptor. Examples include one or more colorants, fluorescent materials, pearlescent materials, iridescent materials, metallic materials, flip-flop pigments, silica, polymeric beads, reflective and non-reflective glass beads, mica, combinations of these, and the like. The amount of visual enhancement additive coated on binder particles may vary over a wide range. In representative embodiments, a suitable weight ratio of copolymer to visual enhancement additive is from 1/1 to 20/1, preferably from 2/1 to 10/1 and most preferably from 4/1 to 8/1.

Useful colorants are well known in the art and include materials listed in the Colour Index, as published by the Society of Dyers and Colourists (Bradford, England), including dyes, stains, and pigments. Preferred colorants are pigments which may be combined with ingredients comprising the binder polymer to form dry toner particles with structure as described herein, are at least nominally insoluble in and nonreactive with the carrier liquid, and are useful and effective in making visible the latent electrostatic image. It is understood that the visual enhancement additive(s) may also interact with each other physically and/or chemically, forming aggregations and/or agglomerates of visual enhancement additives that also interact with the binder polymer. Examples of suitable colorants include: phthalocyanine blue (C.I. Pigment Blue 15:1, 15:2, 15:3 and 15:4), monoarylide yellow (C.I. Pigment Yellow 1, 3, 65, 73 and 74), diarylide yellow (C.I. Pigment Yellow 12, 13, 14, 17 and 83), arylamide (Hansa) yellow (C.I. Pigment Yellow 10, 97, 105 and 111), isoindoline yellow (C.I. Pigment Yellow 138), azo red (C.I. Pigment Red 3, 17, 22, 23, 38, 48:1, 48:2, 52:1, and 52:179), quinacridone magenta (C.I. Pigment Red 122, 202 and 209), laked rhodamine magenta (C.I. Pigment Red 81:1, 81:2, 81:3, and 81:4), and black pigments such as finely divided carbon (Cabot Monarch 120, Cabot Regal 300R, Cabot Regal 350R, Vulcan X72, and Aztech EK 8200), and the like.

The toner particles of the present invention may additionally comprise one or more additives as desired. Additional additives include, for example, UV stabilizers, mold inhibitors, bactericides, fungicides, antistatic agents, anticaking agents, gloss modifying agents, other polymer or oligomer material, antioxidants, and the like.

The additives may be incorporated in the binder particle in any appropriate manner, such as combining the binder particle with the desired additive and subjecting the resulting composition to one or more mixing processes. Examples of such mixing processes include homogenization, microfluidization, ball-milling, attritor milling, high energy bead (sand) milling, basket milling or other techniques known in the art to reduce particle size in a dispersion. The mixing process acts to break down aggregated additive particles, when present, into primary particles (preferably having a diameter of about 0.05 to about 50.0 microns, more preferably having a diameter of about 3 to about 10 microns, most preferably having a diameter of about 5 to about 7 microns) and may also partially shred the binder into fragments that can associate with the additive. According to this embodiment, the copolymer or fragments derived from the copolymer then associate with the additives. Optionally, one or more visual enhancement agents may be incorporated within the binder particle, as well as coated on the outside of the binder particle.

One or more charge control agents can be added before or after this mixing process, if desired. Charge control agents are often used in dry toner when the other ingredients, by themselves, do not provide the desired triboelectric charging or charge retention properties. The amount of the charge control agent, based on 100 parts by weight of the toner solids, is generally 0.01 to 10 parts by weight, preferably 0.1 to 5 parts by weight.

Examples of positive charge control agents for the toner include nigrosine; modified products based on metal salts of fatty acids; quaternary-ammonium-salts such as tributylbenzylammonium-1-hydroxy-4-naphthosulfonic acid or tetrabutylammonium tetrafluoroborate; alkyl pyridinium halides, including cetyl pyridinium chloride and others as disclosed in U.S. Pat. No. 4,298,672; sulfates and bisulfates, including distearyl dimethyl ammonium methyl sulfate as disclosed in U.S. Pat. No. 4,560,635; distearyl dimethyl ammonium bisulfate as disclosed in U.S. Pat. No. 4,937,157, U.S. Pat. No. 4,560,635; onium salts analogous to the quaternary-ammonium-salts such as phosphonium salts, and lake pigments of these; triphenylmethane dyes, and lake pigments of these; metal salts of higher fatty acids; diorgano tin oxides such as dibutyl tin oxide, dioctyl tin oxide, and dicyclohexyl tin oxide; and diorgano tin borates such as dibutyl tin borate, dioctyl tin borate, and dicyclohexyl tin borate.

Further, homopolymers of monomers having the following general formula (1) or copolymers with the foregoing polymerizable monomers such as styrene, acrylic acid esters, and methacrylic acid esters may be used as the positive charge control agent. In that case, those charge control agents have functions also as (all or a part of) binder resins. 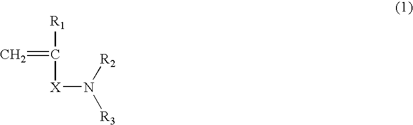
R₁ is H or CH₃;
X is a linking group, such as a —(CH₂)ₘ— group, where m is an integer between 1 and 20, inclusive, and one or more of the methylene groups is optionally replaced by —O—, —(O)C—, —O—C(O)—, —(O)C—O—. Preferably, X is selected from alkyl, 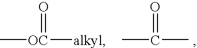
and alkyl-O-alkyl, where the alkyl group has from 1 to 4 carbons.
R₂ and R₃ are independently a substituted or unsubstituted alkyl group having (preferably 1 to 4 carbons).

Examples of commercially available positive charge control agents include azine compounds such as BONTRON N-01, N-04 and N-21; and quaternary ammonium salts such as BONTRON P-51 from Orient Chemical Company and P-12 from Esprix Technologies; and ammonium salts such as “Copy Charge PSY” from Clariant.

Examples of negative charge control agents for the toner include organometal complexes and chelate compounds. Representative complexes include monoazo metal complexes, acetylacetone metal complexes, and metal complexes of aromatic hydroxycarboxylic acids and aromatic dicarboxylic acids. Additional negative charge control agents include aromatic hydroxylcarboxylic acids, aromatic mono- and poly-carboxylic acids, and their metal salts, anhydrides, esters, and phenolic derivatives such as bisphenol. Other negative charge control agents include zinc compounds as disclosed in U.S. Pat. No. 4,656,112 and aluminum compounds as disclosed in U.S. Pat. No. 4,845,003.

Examples of commercially available negatively charged charge control agents include zinc 3,5-di-tert-butyl salicylate compounds, such as BONTRON E-84, available from Orient Chemical Company of Japan; zinc salicylate compounds available as N-24 and N-24HD from Esprix Technologies; aluminum 3,5-di-tert-butyl salicylate compounds, such as BONTRON E-88, available from Orient Chemical Company of Japan; aluminum salicylate compounds available as N-23 from Esprix Technologies; calcium salicylate compounds available as N-25 from Esprix Technologies; zirconium salicylate compounds available as N-28 from Esprix Technologies; boron salicylate compounds available as N-29 from Esprix Technologies; boron acetyl compounds available as N-31 from Esprix Technologies; calixarenes, such as such as BONTRON E-89, available from Orient Chemical Company of Japan; azo-metal complex Cr (III) such as BONTRON S-34, available from Orient Chemical Company of Japan; chrome azo complexes available as N-32A, N-32B and N-32C from Esprix Technologies; chromium compounds available as N-22 from Esprix Technologies and PRO-TONER CCA 7 from Avecia Limited; modified inorganic polymeric compounds such as Copy Charge N4P from Clariant; and iron azo complexes available as N-33 from Esprix Technologies.

Preferably, the charge control agent is colorless, so that the charge control agent does not interfere with the presentation of the desired color of the toner. In another embodiment, the charge control agent exhibits a color that can act as an adjunct to a separately provided colorant, such as a pigment. Alternatively, the charge control agent may be the sole colorant in the toner. In yet another alternative, a pigment may be treated in a manner to provide the pigment with a positive charge.

Examples of positive charge control agents having a color or positively charged pigments include Copy Blue PR, a triphenylmethane from Clariant. Examples of negative charge control agents having a color or negatively charged pigments include Copy Charge NY VP 2351, an Al-azo complex from Clariant; Hostacoply N4P-N101 VP 2624 and Hostacoply N4P-N203 VP 2655, which are modified inorganic polymeric compounds from Clariant.

The preferred amount of charge control agent for a given toner formulation will depend upon a number of factors, including the composition of the polymer binder. The preferred amount of charge control agent further depends on the composition of the S portion of the graft copolymer, the composition of the organosol, the molecular weight of the organosol, the particle size of the organosol, the core/shell ratio of the graft copolymer, the pigment used in making the toner, and the ratio of organosol to pigment. In addition, preferred amounts of charge control agent will also depend upon the nature of the electrophotographic imaging process, particularly the design of the developing hardware and photoreceptive element. It is understood, however, that the level of charge control agent may be adjusted based on a variety of parameters to achieve the desired results for a particular application.

Dry electrophotographic toner compositions of the present invention may be prepared by techniques as generally described above, including the steps of forming an amphipathic copolymer and formulating the resulting amphipathic copolymer into a dry electrophotographic toner composition. As noted above, the amphipathic copolymer is prepared in a liquid carrier to provide a copolymer having portions with the indicated solubility characteristics. Optionally, the plasticizer can be incorporated in the liquid carrier of this reaction process.

Addition of components of the ultimate toner composition, such as charge control agents or visual enhancement additives, can optionally be accomplished during the formation of the amphipathic copolymer. The step of formulating the resulting amphipathic copolymer into a dry electrophotographic toner composition comprises removing the carrier liquid from the composition to the desired level so that the composition behaves as a dry toner composition, and also optionally incorporating other desired additives such as charge control agents, visual enhancement additives, or other desired additives such as described herein to provide the desired toner composition.

The toner particles can be dried by any desired process, such as, for example, by filtration and subsequent drying of the filtrate by evaporation, optionally assisted with heating. Preferably, this process is carried out in a manner that minimizes agglomeration and/or aggregation of the toner particles into one or more large masses. If such masses form, they can optionally be pulverized or otherwise comminuted in order to obtain dry toner particles of an appropriate size.

Alternative drying configurations can be used, such as by coating the toner dispersed in the reaction solvent onto a drying substrate, such as a moving web. In a preferred embodiment, the coating apparatus includes a coating station at which the liquid toner is coated onto surface of a moving web wherein the charged toner particles are coated on the web by an electrically biased deposition roller. A preferred system for carrying out this coating process is described copending U.S. Utility Patent Application Ser. No. 10/881,637, filed Jun. 30, 2004, titled “DRYING PROCESS FOR TONER PARTICLES USEFUL IN ELECTROGRAPHY.” An alternative preferred system comprises using extrusion techniques to help transfer toner particles, which may or may not be charged at this stage, from a reaction solvent onto a substrate surface. A relatively thin coating of extruded particles is formed on the surface as a consequence. Because the resultant coating has a relatively large drying surface area per gram of particle incorporated into the coating, drying can occur relatively quickly under moderate temperature and pressure conditions. A preferred system for carrying out this drying process is described in copending U.S. Utility Patent Application Ser. No. 10/880,799, filed Jun. 30, 2004, titled “EXTRUSION DRYING PROCESS FOR TONER PARTICLES USEFUL IN ELECTROGRAPHY.”

The coated toner particles can optionally be squeezed to eliminate excess reaction solvent by passing the coated web between at least one pair of calendaring rollers. The calendaring rollers preferably can be provided with a slight bias that is higher than the deposition roller applied to keep the charged toner particles from transferring off the moving web. Downstream from the coating station components, the moving web preferably passes through a drying station, such as an oven, in order to remove the remaining reaction solvent to the desired degree. Although drying temperatures may vary, drying preferably occurs at a web temperature that is at least about 5° C. and more preferably at least about 10° C., below the effective T_{g} of the toner particles. After emerging from oven, the dried toner particles on the moving web are preferably passed through a deionizer unit to help eliminate triboelectric charging, and are then gently removed from the moving web (such as by scraping with a plastic blade) and deposited into a collection device at a particle removal station.

The resulting toner particle may optionally be further processed by additional coating processes or surface treatment such as spheroidizing, flame treating, and flash lamp treating. If desired, the toner particle may be additionally milled by conventional techniques, such as using a planetary mill, to break apart any undesired particle aggregates.

The toner particles may then be provided as a toner composition, ready for use, or blended with additional components to form a toner composition. In a preferred embodiment of the present invention, the plasticizer can be incorporated into the dry toner composition after all other toner composition preparation steps have been completed. In a particularly preferred embodiment, the plasticizer is incorporated into the dry toner composition immediately prior to the imaging operation using the toner composition.

Toners of the present invention are in a preferred embodiment used to form images in electrophotographic processes. While the electrostatic charge of either the toner particles or photoreceptive element may be either positive or negative, electrophotography as employed in the present invention is preferably carried out by dissipating charge on a positively charged photoreceptive element. A positively-charged toner is then applied to the regions in which the positive charge was dissipated using a toner development technique.

The invention will further be described by reference to the following nonlimiting examples.

### EXAMPLES

1. Glossary of Chemical Abbreviations & Chemical Sources

The following examples are used in the examples which follow;

AIBN: Azobisisobutyronitrile (a free radical forming initiator available as VAZO-64 from DuPont Chemical Co., Wilmington, Del.)

DBTDL: Dibutyl tin dilaurate (a catalyst available from Aldrich Chemical Co., Milwaukee, Wis.)

EMA: Ethyl methacrylate (available from Aldrich Chemical Co., Milwaukee, Wis.)

EZ Kut: EZ Kut™ 700 electric discharge machining oil (available from EZ Kut Fluid Products Div., Chandler, Ariz.)

HEMA: 2-Hydroxyethyl methacrylate (available from Aldrich Chemical Co., Milwaukee, Wis.)

Mogul L-Black pigment (available from Cabot Corp., Bellerica, Mass.)

TCHMA: 3,3,5-Trimethyl cyclohexyl methacrylate (available from Ciba Specialty Chemical Co., Suffolk, Va.)

TMI: Dimethyl-m-isopropenyl benzyl isocyanate (available from CYTEC Industries, West Paterson, N.J.)

V-601: Dimethyl 2,2′-azobisisobutyrate (a free radical forming initiator available as V-601 from WAKO Chemicals U.S.A., Richmond, Va.)

Zirconium HEX-CEM: metal soap, zirconium tetraoctoate (available from OMG Chemical Company, Cleveland, Ohio)

2. Test Methods and Procedures

Percent Solids

In the following toner composition examples, percent solids of the graft stabilizer solutions and the organosol and liquid toner dispersions were determined thermo-gravimetrically by drying in an aluminum weighing pan an originally-weighed sample at 160° C. for two hours for graft stabilizer, three hours for organosol, and two hours for liquid toner dispersions, weighing the dried sample, and calculating the percentage ratio of the dried sample weight to the original sample weight, after accounting for the weight of the aluminum weighing pan. Approximately two grams of sample were used in each determination of percent solids using this thermo-gravimetric method.

Molecular Weight

In the practice of the invention, molecular weight is normally expressed in terms of the weight average molecular weight, while molecular weight polydispersity is given by the ratio of the weight average molecular weight to the number average molecular weight. Molecular weight parameters were determined with gel permeation chromatography (GPC) using a Hewlett Packard Series II 1190 Liquid Chromatograph made by Agilent Industries (formerly Hewlett Packard, Palo Alto, Calif.) (using software HPLC Chemstation Rev A.02.02 1991-1993). Tetrahydrofuran was used as the carrier solvent. The three columns used in the Liquid Chromatograph were Jordi Gel Columns (DVB 1000A, and DVB10000A and DVB100000A; Jordi Associates, Inc., Bellingham, Mass.). Absolute weight average molecular weight were determined using a Dawn DSP-F light scattering detector (software by Astra v.4.73.04 1994-1999) (Wyatt Technology Corp., Santa Barbara, Calif.), while polydispersity was evaluated by ratioing the measured weight average molecular weight to a value of number average molecular weight determined with an Optilab DSP Interferometric refractometer detector (Wyatt Technology Corp., Santa Barbara, Calif.).

Particle Size

The organosol particle size distributions were determined using a Horiba LA-920 laser diffraction particle size analyzer (commercially obtained from Horiba Instruments, Inc, Irvine, Calif.) using Norpar™ 12 fluid that contains 0.1% Aerosol OT (dioctyl sodium sulfosuccinate, sodium salt, Fisher Scientific, Fairlawn, N.J.) surfactant.

The dry toner particle size distributions were determined using a Horiba LA-900 laser diffraction particle size analyzer (commercially obtained from Horiba Instruments, Inc. Irvine, Calif.) using de-ionized water that contains 0.1% Triton X-100 surfactant (available from Union Carbide Chemicals and Plastics, Inc., Danbury, Conn.).

Prior to the measurements, samples were pre-diluted to approximately 1% by the solvent (i.e., Norpar™ 12 or water). Liquid toner samples are were sonicated for 6 minutes in a Probe VirSonic sonicator (Model-550 by The VirTis Company, Inc., Gardiner, N.Y.). Dry toner samples were sonicated in water for 20 seconds using a Direct Tip Probe VirSonic sonicator (Model-600 by The VirTis Company, Inc., Gardiner, N.Y.). In both procedures, the samples were diluted by approximately 1/500 by volume prior to sonication. Sonication on the Horiba LA-920 was operated at 150 watts and 20 kHz. The particle size was expressed on a number-average (Dₙ) basis in order to provide an indication of the fundamental (primary) particle size, or was expressed on a volume-average (Dv) basis in order to provide an indication of the size of the coalesced, agglomerated primary particles.

Glass Transition Temperature

Thermal transition data for synthesized TM was collected using a TA Instruments Model 2929 Differential Scanning Calorimeter (DSC) (New Castle, Del.) equipped with a DSC refrigerated cooling system (−70° C. minimum temperature limit), and dry helium and nitrogen exchange gases. The calorimeter ran on a Thermal Analyst 2100 workstation with version 8.10B software. An empty aluminium pan was used as the reference. The samples were prepared by placing 6.0 to 12.0 mg of the experimental material into an aluminum sample pan and crimping the upper lid to produce a hermetically sealed sample for DSC testing. The results were normalized on a per mass basis. Each sample was evaluated using 20° C./min heating and cooling rates with a 5-10 min isothermal bath at the end of each heating or cooling ramp. The experimental materials were heated four times: the first heat ramp provides any crystalline melting point of volatile plasiticizer and removes the previous thermal history. Subsequent heat ramps are used to obtain a stable glass transition temperature value—values are reported from all heat ramps.

Toner Charge (Blow-Off Q/M)

One important characteristic of xerographic toners is the toner's electrostatic charging performance (or specific charge), given in units of Coulombs per gram. The specific charge of each toner was established in the examples below using a blow-off tribo-tester instrument (Toshiba Model TB200 Blow-Off Powder Charge measuring apparatus with size #400 mesh stainless steel screens pre-washed in tetrahydrofuran and dried over nitrogen, Toshiba Chemical Co., Tokyo, Japan).

To measure the specific charge of each toner, a 0.5 g toner sample was first electrostatically charged by combining it with 9.5 g of MgCuZn Ferrite carrier beads (Steward Corp., Chattanooga, Tenn.) to form the developer in a plastic container. This developer was gently agitated using a U.S. Stoneware mill mixer for 5 min, 15 min, and 30 min intervals before 0.2 g of the toner/carrier developer was analyzed using a Toshiba Blow-off tester to obtain the specific charge (in microCoulombs/gram) of each toner. Specific charge measurements were repeated at least three times for each toner to obtain a mean value and a standard deviation. The measurements were monitored for validity, namely, a visual observation that nearly all of the toner was blown-off of the carrier during the measurement. Tests were considered valid if nearly all of toner mass is blown-off from the carrier beads. Tests with low mass loss were rejected.

Dry Toner Milling Procedure

Dry toner particles were milled to a smaller size or to a more uniform range, or with additional additives (such as wax) using a planetary mono mill model LC-106A manufactured by Fritsch GMBH of Idar-Oberstien, Germany. Thirty-five grinding balls made of silicon-nitride (Si₃N₄) and having a 10 mm diameter were put into an 80 ml grinding bowl also made of Si₃N₄. Both the grinding balls and grinding bowl were manufactured by Fritsch GMBH. The toner (and any other optional additives) were weighed into the grinding bowl, then the grinding bowl is covered and securely mounted in the planetary mill. The planetary mill was run at 600 RPM for three milling cycles each lasting 3 minutes, 20 seconds. The mill was shut down for 5 minute periods between the first and second milling cycles and between the second and third milling cycles to minimize temperature increase within the grinding bowl. After the third milling cycle was completed, the grinding bowl was removed from the planetary mill and the grinding balls separated by pouring the contents onto a # 35 sieve. The milled toner powder was passed through the sieve onto a collection sheet and subsequently sealed in an airtight glass jar.

### Nomenclature

In the following examples, the compositional details of each copolymer will be summarized by ratioing the weight percentages of monomers used to create the copolymer. The grafting site composition is expressed as a weight percentage of the monomers comprising the copolymer or copolymer precursor, as the case may be. For example, a graft stabilizer (precursor to the S portion of the copolymer) designated TCHMA/HEMA-TMI (97/3-4.7% w/w) is made by copolymerizing, on a relative basis, 97 parts by weight TCHMA and 3 parts by weight HEMA, and this hydroxy functional polymer was reacted with 4.7 parts by weight of TMI.

Similarly, a graft copolymer organosol designated TCHMA/HEMA-TMI//EMA (97/3-4.7//100% w/w) is made by copolymerizing the designated graft stabilizer (TCHMA/HEMA-TMI (97/3-4.7% w/w)) (S portion or shell) with the designated core monomer EMA (D portion or core, 100% EMA) at a specified ratio of D/S (core/shell) determined by the relative weights reported in the examples.

Graft Stabilizer Preparations

### EXAMPLE 1

A 5000 ml, 3-neck round bottom flask equipped with a condenser, a thermocouple connected to a digital temperature controller, a nitrogen inlet tube connected to a source of dry nitrogen and a mechanical stirrer, was charged with a mixture of 2573 g of hepane, 848.8 g of TCHMA, 26.8 g of HEMA, and 8.75 g of V-601. While stirring the mixture, the reaction flask was purged with dry nitrogen for 30 minutes at flow rate of approximately 2 liters/minute. A hollow glass stopper was then inserted into the open end of the condenser and the nitrogen flow rate was reduced to approximately 0.5 liters/minute. The mixture was heated to 75° C. for 4 hours. The conversion was quantitative.

The mixture was then heated to 95° C. and held at that temperature for 1 hour to destroy any residual V-601, and then was cooled back to 70° C. The nitrogen inlet tube was then removed, and 1.36 g of 95% (w/w) DBTDL was added to the mixture, followed by 41.1 g of TMI. The TMI was added drop wise over the course of approximately 5 minutes while stirring the reaction mixture. The nitrogen inlet tube was replaced, the hollow glass stopper in the condenser was removed, and the reaction flask was purged with dry nitrogen for 30 minutes at a flow rate of approximately 2 liters/minute. The hollow glass stopper was reinserted into the open end of the condenser and the nitrogen flow rate was reduced to approximately 0.5 liters/min. The mixture was allowed to react at 70° C. for 6 hours, at which time the conversion was quantitative.

The mixture was then cooled to room temperature. The cooled mixture was a viscous, transparent liquid containing no visible insoluble mater. The percent solids of the liquid mixture was determined to be 26.7% (w/w) using the drying method described above. Subsequent determination of molecular weight was made using the GPC method described above; the copolymer had an M_{w} of 194,750 Da and M_{w}/Mₙ of 2.4 based on two independent measurements. The product was a copolymer of TCHMA, and HEMA, and DMEMA with a TMI grafting site and was designated herein as TCHMA/HEMA-TMI/(97/3-4.7% w/w) and suitable for making an organosol. The glass transition temperature was measured using DSC, as described above. The shell co-polymer had a T_{g} of 126° C.

TABLE 1
Graft Stabilizer

| Example | Graft Stabilizer | Solids | Molecular Weight | |
|---|---|---|---|---|
| Number | Composition (% w/w) | % (w/w) | M_{w} | M_{w}/Mₙ |
| 1 | TCHMA/HEMA-TMI | 26.7 | 194,750 | 2.4 |
| | (97/3-4.7% w/w) | | | |

Organosol Preparations

### EXAMPLE 2

A 0.72 l (32 oz.), narrow-mouthed glass bottle was charged with 505 g of heptane, 64 g of EMA, 30 g of graft stabilizer from Example 1, and 0.72 g of V-601. The bottle was purged with nitrogen then sealed with a screw cap fitted with a Teflon™ liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours, at which time the conversion of monomer and stabilizer to polymer was quantitative.

The cooled mixture was a white opaque fluid. The percent solids of the liquid mixture was determined to be 12.0% (w/w) using the thermogravimetric method described above, and the mean volume particle size was found to be 0.42 μm. This organosol was suitable for making a toner.

### EXAMPLE 3

A 0.72 l (32 oz.), narrow-mouthed glass bottle was charged with 480 g of heptane, 25 g of Isopar™ G, 64 g of EMA, 30 g of graft stabilizer from Example 1, and 0.72 g of V-601. The bottle was purged with nitrogen then sealed with a screw cap fitted with a Teflon™ liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours, at which time the conversion of monomer and stabilizer to polymer was quantitative.

The cooled mixture was a white opaque fluid. The percent solids of the liquid mixture was determined to be 11.8% (w/w) using the thermogravimetric method described above, and the mean volume particle size was found to be 0.41 μm. This organosol was suitable for making a toner.

### EXAMPLE 4

A 0.72 liter (32 oz.), narrow-mouthed glass bottle was charged with 503.74 g of n-heptane, 1.26 g of dibutyl phthalate, 64 g of EMA, 30 g of graft stabilizer from Example 1, and 0.72 g of V-601. The bottle was purged with nitrogen then sealed with a screw cap fitted with a Teflon™ liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours, at which time the conversion of monomer and stabilizer to polymer was quantitative.

The cooled mixture was a white opaque fluid. The percent solids of the liquid mixture was determined to be 11.4% (w/w) using the thermogravimetric method described above, and the mean volume particle size was found to be 0.38 μm. This organosol was suitable for making a toner.

### EXAMPLE 5

A 0.72 liter (32 oz.), narrow-mouthed glass bottle was charged with 499.5 g of n-heptane, 5.05 g of dibutyl phthalate (available from Aldrich Chemicals, Milwaukee, Wi.), 64 g of EMA, 30 g of graft stabilizer from Example 1, and 0.72 g of V-601. The bottle was purged with nitrogen then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours, at which time the conversion of monomer and stabilizer to polymer was quantitative.

The cooled mixture was a white opaque fluid. The percent solids of the liquid mixture was determined to be 11.6% (w/w) using the thermogravimetric method described above, and the mean volume particle size was found to be 0.42 μm. This organosol was suitable for making a toner.

### EXAMPLE 6

A 0.72 liter (32 oz.), narrow-mouthed glass bottle was charged with 499.5 g of n-heptane, 5.05 g of dibutyl phthalate (available from Aldrich Chemicals, Milwaukee, Wi.), 64 g of EMA, 30 g of graft stabilizer from Example 1, and 0.72 g of V-601. The bottle was purged with nitrogen then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours, at which time the conversion of monomer and stabilizer to polymer was quantitative.

The cooled mixture was a white opaque fluid. The percent solids of the liquid mixture was determined to be 11.6% (w/w) using the thermogravimetric method described above, and the mean volume particle size was found to be 0.42 μm. This organosol was suitable for making a toner.

### EXAMPLE 7

A 0.72 liter (32 oz.), narrow-mouthed glass bottle was charged with 499.5 g of n-heptane, 5.05 g of dibutyl phthalate (available from Aldrich Chemicals, Milwaukee, Wi.), 64 g of EMA, 30 g of graft stabilizer from Example 1, and 0.72 g of V-601. The bottle was purged with nitrogen then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours at which time the conversion of monomer and stabilizer to polymer was quantitative.

The cooled mixture was a white opaque fluid. The percent solids of the liquid mixture was determined to be 11.6% (w/w) using the thermogravimetric method described above, and the mean volume particle size was found to be 0.4 μm. This was suitable for making a toner.

### EXAMPLE 8

A 0.72 liter (32 oz.), narrow-mouthed glass bottle was charged with 503 g of n-heptane, 2.5 g of Methyl Oleate (available from Aldrich Chemicals, Milwaukee, Wi.), 64 g of EMA, 30 g of graft stabilizer from Example 1, and 0.72 g of V-601. The bottle was purged with nitrogen then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours at which time the conversion of monomer and stabilizer to polymer was quantitative.

The cooled mixture was a white opaque fluid. The percent solids of the liquid mixture was determined to be 11.1% (w/w) using the thermogravimetric method described above, and the mean volume particle size was found to be 0.38 μm. This was suitable for making a toner.

### EXAMPLE 9

A 0.72 liter (32 oz.), narrow-mouthed glass bottle was charged with 500 g of n-heptane, 5.05 g of Methyl Oleate (available from Aldrich Chemicals, Milwaukee, Wis.), 64 g of EMA, 30 g of graft stabilizer from Example 1, and 0.72 g of V-601. The bottle was purged with nitrogen then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours at which time the conversion of monomer and stabilizer to polymer was quantitative.

The cooled mixture was a white opaque fluid. The percent solids of the liquid mixture was determined to be 11.1% (w/w) using the thermogravimetric method described above, and the mean volume particle size was found to be 0.39 μm. This was suitable for making a toner.

### EXAMPLE 10

A 0.72 liter (32 oz.), narrow-mouthed glass bottle was charged with 500 g of n-heptane, 5.05 g of EZ Kut™ 700 (available from EZ Kut, Fluid Prod. Div., Chandler, Ariz.), 64 g of EMA, 30 g of graft stabilizer from Example 1, and 0.72 g of V-601. The bottle was purged with nitrogen then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours at which time the conversion of monomer and stabilizer to polymer was quantitative.

The cooled mixture was a white opaque fluid. The percent solids of the liquid mixture was determined to be 11.1% (w/w) using the thermogravimetric method described above, and the mean volume particle size was found to be 0.39 μm. This was suitable for making a toner.

### EXAMPLE 11

A 0.72 liter (32 oz.), narrow-mouthed glass bottle was charged with 503 g of n-heptane, 2.5 g of EZ Kut™ 700 (available EZ Kut, Fluid Prod. Div., Chandler, Ariz.), 64 g of EMA, 30 g of graft stabilizer from Example 1, and 0.72 g of V-601. The bottle was purged with nitrogen then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours at which time the conversion of monomer and stabilizer to polymer was quantitative.

The cooled mixture was a white opaque fluid. The percent solids of the liquid mixture was determined to be 11.1% (w/w) using the thermogravimetric method described above, and the mean volume particle size was found to be 0.21 μm. This was suitable for making a toner.

### EXAMPLE 12

A 0.72 liter (32 oz.), narrow-mouthed glass bottle was charged with 504 g of n-heptane, 1.26 g of EZ Kut™ 700 (available EZ Kut, Fluid Prod. Div., Chandler, Ariz.), 64 g of EMA, 30 g of graft stabilizer from Example 1, and 0.72 g of V-601. The bottle was purged with nitrogen then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 5 hours at which time the conversion of monomer and stabilizer to polymer was quantitative.

The cooled mixture was a white opaque fluid. The percent solids of the liquid mixture was determined to be 11.1% (w/w) using the thermogravimetric method described above, and the mean volume particle size was found to be 0.39 μm. This was suitable for making a toner.

Toner Preparations

### EXAMPLE 13

### Comparative

This is a comparative example of preparing a black liquid toner having no volatile plasticizer at an organosol/pigment ratio of 6/1 using the organosol prepared at a D/S ratio of 6/1 in Example 2.288 g of the organosol @ 11.7% (w/w) solids in n-heptane were combined with 8.2 g of n-heptane, 5.6 g Mogul L, and 0.5 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 45° C.

About 150 g of the above toner was dried in an aluminum weighing pan for 72 hours, scraped off and Fritsch milled according to the above method. After milling, the sample was redried at 160° C. for one hour (thereby removing substantially all of the heptane solvent) prior to testing for glass transition temperature by the above method. The mean volume particle size was found to be 25 μm. The fusing characteristics and electrostatic data are described in the table below.

### EXAMPLE 14

This is an example of preparing a black liquid toner having a volatile plasticizer at an organosol/pigment ratio of 6/1 using the organosol prepared at a D/S ratio of 6/1 in Example 2.288 g of the organosol @ 11.7% (w/w) solids in n-heptane were combined with 8.2 g of n-heptane, 5.6 g of black pigment Mogul L, and 0.5 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 45° C. The percent solids of the toner concentrate was determined to be 13.3% (w/w) using the thermo-gravimetric method described above.

About 150 g of the above toner was dried in an aluminum weighing pan for 72 hours, scraped off and Fritsch milled according to the above method. Because this sample did not undergo a redrying step as carried out in Example 13, heptane volatile plasticizer was retained in this toner. Mean volume particle size was found to be 25 μm. The fusing characteristics and electrostatic data are described in the table below.

### EXAMPLE 15

This is an example of preparing a black liquid toner having a volatile plasticizer at an organosol/pigment ratio of 6/1 using the organosol prepared at a D/S ratio of 6/1 in Example 3.283 g of the organosol @ 11.8% (w/w) solids in n-heptane were combined with 10.6 g of n-heptane, 5.6 g of Mogul L, and 0.5 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 30 minutes 45° C.

About 150 g of the above toner was dried in an aluminum weighing pan for 72 hours, scraped off and Fritsch milled according to the above method. Mean volume particle size was found to be 91 μm. The fusing characteristics and electrostatic data are described in the table below.

### EXAMPLE 16

This is an example of preparing a black liquid toner having a volatile plasticizer at an organosol/pigment ratio of 6/1 using the organosol prepared at a D/S ratio of 6/1 in Example 4.293 g of the organosol @ 11.4% (w/w) solids in n-heptane were combined with 0.6 g of n-heptane, 5.6 g of Mogul L, and 0.6 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 30 minutes at 45° C.

About 150 g of the above toner was dried in an aluminum weighing pan for 72 hours, scraped off and Fritsch milled using the above method. Mean volume particle size was found to be 24 μm. The fusing characteristics and electrostatic data are described in the table below.

### EXAMPLE 17

### Comparative

This is an example of preparing a black liquid toner having a volatile plasticizer at an organosol/pigment ratio of 6/1 using the organosol prepared at a D/S ratio of 6/1 in Example 5.293 g of the organosol @ 11.4% (w/w) solids in n-heptane were combined with 0.6 g of n-heptane, 5.6 g of Mogul L, and 0.6 g of 5.2% (w/w) Zirconium HEX-CEM solution in an 8 ounce glass jar. This mixture was then milled in a 0.5 liter vertical bead mill (Model 6TSG-1/4, Amex Co., Ltd., Tokyo, Japan) charged with 390 g of 1.3 mm diameter Potters glass beads (Potters Industries, Inc., Parsippany, N.J.). The mill was operated at 2,000 RPM for 30 minutes at 45° C. The percent solids of the toner concentrate was determined to be 13.4% (w/w) using the thermo-gravimetric method described above.

About 150 g of the above toner was dried in an aluminum weighing pan for 72 hours, scraped off and Fritsch milled using the above method. Mean volume particle size was found to be 24 μm. The fusing characteristics and electrostatic data are described in the table below.

Data

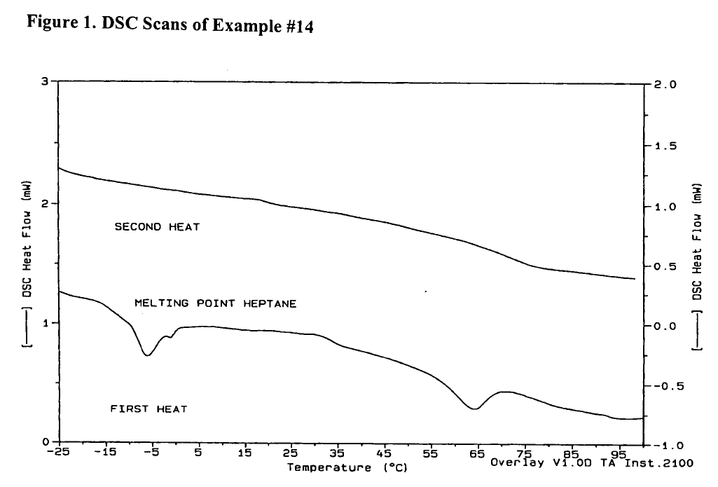

FIG. 1 shows a DSC plot of an exemplary volatile plasticizer (Example #14). The plasticizer is reflected in the first scan by its crystalline melting point. In subsequent scans, (ie. after fusing temperature has been attained) no melt transition is observed, reflecting loss of plasticizer by evaporation. Note the disappearance of the heptane crystalline melting point in the second heat. In a printing situation, the heptane would have had a plasticizing effect during fusing. The heptane is then vaporized in the fusing process, leaving a higher T_{g}, durable, fused toner image on paper.

Physical measurement data from Examples 13-17 above is presented in Table 2.

TABLE 2
Summary of Data for Volatile Plasticizer-containing Dry Toners

| | | Plasticizer | | | | |
|---|---|---|---|---|---|---|
| | | amount | | | | |
| | | (% (w/w)) | Melt Transition | | | |
| | | based on | Data | | | |
| Exam- | Plasti- | carrier | | Tm | Tg | |
| ple # | cizer | fluid | Heat # | (° C.) | (° C.) | Q/M |
| 13 | None | 0 | Heat 1 | not observed | 86 | 4.5023 |
| | (Compar- | | Heat 2 | not observed | 79.9 | |
| | ative) | | Heat 3 | not observed | 80.2 | |
| | | | Heat 4 | not observed | 83.7 | |
| 14 | Heptane | 0.045 | Heat 1 | −11 | 61.19 | NA |
| | (air | | Heat 2 | not observed | 69.08 | |
| | dried) | | Heat 3 | not observed | 69.26 | |
| | | | Heat 4 | not observed | 72.97 | |
| 15 | Isopar G | 1.19 | Heat 1 | 10.24 | 57.39 | −7.311 |
| | | | Heat 2 | not observed | 70.58 | |
| | | | Heat 3 | not observed | 73.67 | |
| | | | Heat 4 | not observed | 68.37 | |
| 16 | Dibutyl | 0.25 | Heat 1 | 10.01 | 60.38 | 6.7966 |
| | Phthalate | | Heat 2 | not observed | 65.51 | |
| | | | Heat 3 | not observed | 67.89 | |
| | | | Heat 4 | not observed | 68.67 | |
| 17 | Dibutyl | 1 | Heat 1 | not observed | 54.35 | |
| | Phthalate | | Heat 2 | not observed | 50.89 | −4.2042 |
| | (compar- | | Heat 3 | not observed | 52.23 | |
| | ative) | | Heat 4 | not observed | 55.48 | |

At the plasticizer concentrations tested, heptane and Isopar G behaved as volatile plasticizers in the toner systems evaluated. Thus, in the first heat evaluation, a melting point corresponding to the crystalline melt point of the plasticizer is observed, and the Tg of the toner is substantially reduced as compared to the toner that does not contain plasticizer (Example 13). In subsequent heating evaluations, the melting point is not observed, and the T_{g} of the toner increases (though not to the level of plasticizer free toner Example 13), both indicating substantial volatilization of the plasticizer. These systems provide a toner that has a lower fusing temperature as compared to like systems that do not have the volatile plasticizer, but having superior durability of final image as compared to toners having the same fusing temperature without plasticizer, because the present plasticizer volatilizes during fusion and is not in the fused toned image on the final image receptor.

Dibutyl phthalate is observed to behave as a volatile plasticizer at lower concentrations (Example 16). At higher concentrations (Example 17), sufficient plasticizer remains in the toner after the first heat evaluation to continue to suppress the T_{g} of the toner.

### EXAMPLE 18

This is an example of preparing a black liquid toner having a volatile plasticizer at an organosol/pigment ratio of 6/1 using the organosol prepared at a D/S ratio of 6/1 in Example 9. 299 g of the organosol @ 11.2% (w/w) solids in n-heptane were combined with 5.6 g of Mogul L, and 0.6 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 30 minutes at 45° C.

About 150 g of the above toner was dried in an aluminum weighing pan for 72 hours, scraped off and Fritsch milled using the above method. Mean volume particle size of the milled toner was found to be 27 μm using the method above. The fusing characteristics and electrostatic data are described in the table below.

### EXAMPLE 19

This is an example of preparing a black liquid toner having a volatile plasticizer at an organosol/pigment ratio of 6/1 using the organosol prepared at a D/S ratio of 6/1 in Example 8.301 g of the organosol @111.1% (w/w) solids in n-heptane were combined with 5.6 g of Mogul L, and 0.6 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 30 minutes at 45° C.

About 150 g of the above toner was dried in an aluminum weighing pan for 72 hours, scraped off and Fritsch milled using the above method. Mean volume particle size of the milled toner was found to be 29 μm using the method above. The fusing characteristics and electrostatic data are described in the table below.

### EXAMPLE 20

### Comparative

This is an example of preparing a black liquid toner having a non-volatile plasticizer at an organosol/pigment ratio of 6/1 using the organosol prepared at a D/S ratio of 6/1 in Example 7.301 g of the organosol @111.1% (w/w) solids in n-heptane were combined 5.6 g of Mogul L, and 0.6 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 30 minutes at 45° C.

About 150 g of the above toner was dried in an aluminum weighing pan for 72 hours, scraped off and Fritsch milled using the above method. Mean volume particle size was found to be 24.2 μm. The fusing characteristics and electrostatic data are described in the table below.

### EXAMPLE 21

This is an example of preparing a black liquid toner having a volatile plasticizer at an organosol/pigment ratio of 6/1 using the organosol prepared at a D/S ratio of 6/1 in Example 12.299 g of the organosol @ 11.1% (w/w) solids in n-heptane were combined with 5.6 g of Mogul L, and 0.6 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 30 minutes at 45° C.

About 150 g of the above toner was dried in an aluminum weighing pan for 72 hours, scraped off and Fritsch milled using the above method. Mean volume particle size of the milled toner was found to be 22.6 μm using the method above. The fusing characteristics and electrostatic data are described in the table below.

### EXAMPLE 22

This is an example of preparing a black liquid toner having a volatile plasticizer at an organosol/pigment ratio of 6/1 using the organosol prepared at a D/S ratio of 6/1 in Example 11.301 g of the organosol @ 11.1% (w/w) solids in n-heptane were combined with 5.6 g of Mogul L, and 0.6 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 30 minutes at 45° C.

About 150 g of the above toner was dried in an aluminum weighing pan for 72 hours, scraped off and Fritsch milled using the above method. Mean volume particle size of the milled toner was found to be 20 μm using the method above. The fusing characteristics and electrostatic data are described in the table below.

### EXAMPLE 23

### Comparative

This is an example of preparing a black liquid toner having a non-volatile plasticizer at an organosol/pigment ratio of 6/1 using the organosol prepared at a D/S ratio of 6/1 in Example 10.299 g of the organosol @ 11.2% (w/w) solids in n-heptane were combined with 5.6 g of Mogul L, and 0.6 g of 5.2% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 30 minutes at 45° C.

About 150 g of the above toner was dried in an aluminum weighing pan for 72 hours, scraped off and Fritsch milled using the above method. Mean volume particle size of the milled toner was found to be 27 μm using the method above. The fusing characteristics and electrostatic data are described in the table below.

TABLE 3
Summary of Data for Plasticizer-Containing Dry Toners

| | | Plasticizer | | | | |
|---|---|---|---|---|---|---|
| | | amount | | | | |
| Exam- | | (% (w/w) | Melt Transition | | | |
| ple | | based on | Data | | | |
| Num- | Plasti- | carrier | | Tₘ | T_{g} | Q/M |
| ber | cizer | fluid) | Heat # | (° C.) | (° C.) | (μC/g) |
| 13 | None | 0 | Heat 1 | not observed | 86 | 4.5023 |
| (Compar- | | | Heat 2 | not observed | 81.75 | |
| ative) | | | Heat 3 | not observed | 79.51 | |
| | | | Heat 4 | not observed | 79.57 | |
| 18 | Methyl | 0.25 | Heat 1 | not observed | 59.28 | 1.5008 |
| | Oleate | | Heat 2 | not observed | 64.76 | |
| | | | Heat 3 | not observed | 68.67 | |
| | | | Heat 4 | not observed | 67.37 | |
| 19 | Methyl | 0.5 | Heat 1 | not observed | 57.58 | |
| | Oleate | | Heat 2 | not observed | 63.65 | 8.6000 |
| | | | Heat 3 | not observed | 64.32 | |
| | | | Heat 4 | not observed | 66.94 | |
| 20 | Methyl | 1 | Heat 1 | not observed | 57.31 | 7.4037 |
| (Compar- | Oleate | | Heat 2 | not observed | 55.88 | |
| ative) | | | Heat 3 | not observed | 51.91 | |
| | | | Heat 4 | not observed | 53.61 | |
| 21 | EZ | 0.25 | Heat 1 | 7.47 | 57.97 | 5.1102 |
| | Kut ™ | | Heat 2 | not observed | 70.89 | |
| | 700 | | Heat 3 | not observed | 69.55 | |
| | | | Heat 4 | not observed | 71.14 | |
| 22 | EZ | 0.5 | Heat 1 | 6.35 | 57.71 | 8.2917 |
| | Kut ™ | | Heat 2 | not observed | 66.28 | |
| | 700 | | Heat 3 | not observed | 65.61 | |
| | | | Heat 4 | not observed | 63.22 | |
| 23 | EZ | 1 | Heat 1 | 5.84 | 55.9 | 8.7868 |
| (Compar- | Kut ™ | | Heat 2 | 7.6 | 59.46 | |
| ative) | 700 | | Heat 3 | 8.1 | 53.35 | |
| | | | Heat 4 | 8.4 | 56.3 | |

In a manner similar to that observed with dibutyl phthalate above, methyl oleate and EZ Kut™ 700 oil are observed to behave as volatile plasticizers at lower concentrations (Examples 18 and 19, and 21 and 22, respectively). Thus, in the first heat evaluation, a melting point corresponding to the crystalline melt point of the plasticizer is observed in the EZ Kut™ 700 oil containing samples, and the T_{g}'s of all plasticizer-containing toners are substantially reduced as compared to the toner that does not contain plasticizer (Example 13). In subsequent heating evaluations, the melting point is not observed, and the T_{g}'s of these toner increase (though not to the level of plasticizer free toner Example 13), both indicating substantial volatilization of the plasticizer. These systems provide a toner that has a lower fusing temperature as compared to like systems that do not have the volatile plasticizer, but having superior durability of final image as compared to toners having the same fusing temperature without plasticizer, because the present plasticizer volatilizes during fusion and is not in the system after the image has been formed. In some cases (e.g. methyl oleate), no initial melting point may be observed in the first DSC heat evaluation. This may result because the plasticizer itself does not exhibit a melt transition over the measured temperature range, or the plasticizer concentration temperature is too low to observe the melt transition.

At higher concentrations (Example 20 and 23, respectively), sufficient plasticizer remains in the toner after the first heat evaluation to continue to suppress the T_{g} of the toner.

Other embodiments of this invention will be apparent to those skilled in the art upon consideration of this specification or from practice of the invention disclosed herein. All patents, patent documents, and publications cited herein are incorporated by reference as if individually incorporated. Various omissions, modifications, and changes to the principles and embodiments described herein can be made by one skilled in the art without departing from the true scope and spirit of the invention which is indicated by the following claims.

What is claimed is:

1. A low temperature fusing dry electrographic toner composition comprising:
a plurality of dry toner particles, wherein the toner particles comprise polymeric binder comprising at least one amphipathic copolymer comprising one or more S material portions and one or more D material portions;
wherein the dry electrographic toner composition comprises a volatile plasticizer in an amount effective to reduce the First Heat Exposure T_{g} by at least about 10° C. as compared to a like electrographic toner composition that does not comprise volatile plasticizer, and wherein the plasticizer is sufficiently volatile that the Second Heat Exposure T_{g} will increase by at least about 5° C. above the First Heat Exposure T_{g}.

2. The dry toner composition of claim 1, wherein the plasticizer is present in an amount of from about 0.01 to about 6% (w/w) of the dry electrographic toner composition.

3. The dry toner composition of claim 1, wherein the plasticizer is present in an amount of from about 0.02 to about 2% (w/w) of the dry electrographic toner composition.

4. The dry toner composition of claim 1, wherein the plasticizer is present in an amount of from about 0.04 to about 1.2% (w/w) of the dry electrographic toner composition.

5. The dry toner composition of claim 1, wherein the plasticizer is selected from the group consisting of straight, branched or cyclo-lower alkyl compounds; straight, branched or cyclo-lower alkyl phthalate compounds; straight, branched or cyclo-lower alkyl esters; C₇-C₁₁ isoparaffinic solvents; and mixtures thereof.

6. The dry toner composition of claim 1, wherein the plasticizer is a volatile machining oil.

7. The dry toner composition of claim 1, wherein the plasticizer is selected from the group consisting of methyl oleate, heptane, dibutyl phthalate, and C₁₀-C₁₁ isoparaffin.

8. A method of preparing a low temperature fusing dry electrographic toner composition comprising:
a) providing a plurality of dry toner particles, wherein the toner particles comprise polymeric binder comprising at least one amphipathic copolymer comprising one or more S material portions and one or more D material portions; and
b) providing volatile plasticizer in the dry electrographic toner composition in an amount effective to reduce the First Heat Exposure T_{g} by at least about 10° C. as compared to a like electrographic toner composition that does not comprise volatile plasticizer, and wherein the plasticizer is sufficiently volatile that the Second Heat Exposure T_{g} will increase by at least about 5° C. above the First Heat Exposure T_{g}.

9. The method of claim 8, wherein the volatile plasticizer is provided after preparation of the toner particles.

10. The method of claim 8, wherein the volatile plasticizer is provided in a reaction solvent during preparation of the toner particles, and wherein in a drying step to remove the reaction solvent, plasticizer remains with the toner particles in an amount effective to reduce the First Heat Exposure T_{g} by at least about 10° C. as compared to a like electrographic toner composition that does not comprise volatile plasticizer, and wherein the plasticizer is sufficiently volatile that the Second Heat Exposure T_{g} will increase by at least about 5° C. above the First Heat Exposure T_{g}.

11. A method of fusing an image using the composition of claim 1, wherein the dry toner composition is provided in an image on a substrate and fused at a temperature above the First Heat Exposure T_{g} of the composition, thereby volatilizing at least a portion of the plasticizer so that the Second Heat Exposure T_{g} of the dry toner composition increases by at least about 5° C. above the First Heat Exposure T_{g}.
